(19) United States
(12) Patent Application Publication
(10) Pub. No.: US 2012/0102821 A1
(43) Pub. Date: May 3, 2012

(54) DISPENSING DEVICE FOR RODENT BAITS

(75) Inventors: Vladin Jovic, Granville New South Wales (AU); Duncan McLeod Watson, Montvale, NJ (US)

(73) Assignee: Reckitt & Colman (Overseas Limited), Slough, Berkshire (GB)

(21) Appl. No.: 13/377,624

(22) PCT Filed: Jun. 7, 2010
(86) PCT No.: PCT/GB2010/050946

§ 371 Date: Jan. 12, 2012

(30) Foreign Application Priority Data
Jun. 26, 2009 (GB) 0911114.7

(51) Int. Cl. A01M 25/00

(52) U.S. Cl. 43/131

(57) ABSTRACT

Disclosed herein are various embodiments of a dispensing device for rodent baits. A first embodiment of the dispensing device (100) includes a body (102) having a floor (104), walls (106) extending from the floor and a top (108) extending between the walls (106). A bait station (110) is located in the body (102). A locating spike (112) extends from the bait station (110) for engagement by a bait (114). A race (116) extends into the body (102) for permitting rodent access to the bait station (110). A door (118) is hingedly connected, about a hinge axis (118a) generally orthogonal to the floor (104), to the body (102). The door (118) is movable between a closed position, in which the door (118) covers the bait station (110), and an open position, for permitting user access to the bait station (110) for bait replenishment.

The present disclosure relates to a dispensing device and in particular to a dispensing device for rodent baits.

The dispensing device has been developed primarily for use in dispensing baits containing poison for exterminating rodents, such as mice and rats. However, it will be appreciated that the dispensing device may also be used for dispensing other poisonous chemicals, for controlling other vermin, such as voles, as well as crawling insects, such as cockroaches and ants, or for dispensing non-poisonous baits/chemicals for therapeutic treatment of wildlife or for monitoring rodent populations.

Known rodent bait dispensing devices typically include a bait box with a hinged lid allowing access to a bait pedestal on which a poisonous bait can be mounted.

A problem with known rodent bait dispensing devices is that they can often be opened by children, who can as a result be exposed to the poisonous bait.

In an effort to deter access by children, some bait stations include one or more complicated locking mechanism for securing the hinged lid against opening by children. However, such complicated locking mechanisms can be difficult for adults, especially the elderly or incapacitated persons, to open to allow bait replenishment.

Other efforts to deter access by children include fitting keyed locks to the dispensing devices. A disadvantage of the use of keyed locks, however, is that the key can be misplaced or lost, which is inconvenient and, in the case of key loss, can prevent the dispensing device from being refilled.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

In a first aspect, there is provided a dispensing device for rodent baits, the dispensing device comprising:

a body having a floor, walls extending from the floor and a top extending between the walls;

a station located in the body for receiving a rodent bait;

a race extending into the body for permitting rodent access to the station;

a door connected to the body, the door being movable between a closed position, in which the door covers the station, and an open position for permitting user access to the station for bait replenishment;

a locking mechanism associated with the hinged door for releasably securing the door in the closed position, the locking mechanism including:
a plurality of independently manually manipulable first locking formations on one of the body and door and corresponding second locking formations on the other of the body and door, the first locking formations being resiliently biased into locking engagement with the second locking formations to releasably secure the door in the closed position;
the locking mechanism being adapted such that each of the first locking formations must be simultaneously manipulated out of locking engagement with the corresponding second locking formations to release the door for movement from the closed position to the open position;
wherein the first locking formations are adapted such that a user must manipulate each of the first locking formations with a different finger of the user's hands.

The first locking formations are preferably adapted such that they must be manipulated with a different finger of the user's hands by virtue of the relative positions of the first locking members.

At least three user actions are preferably required to open the door. Two of the first locking formations and corresponding second locking formations are preferably provided and define two of the required user actions, and the third user action is preferably manual movement of the door between the closed and open positions. The door is preferably hingedly connected to the body for swinging movement between the closed and open positions.

A locating spike preferably extends from the station for engagement by a bait.

In a first family of embodiments, a hinge axis of the door extends generally orthogonal to the floor of the body. The door preferably includes a side portion cooperating with the walls of the body to enclose the station and a cover portion cooperating with the top of the body to enclose the station when the door is in the closed position. The side portion preferably includes a recess for manual engagement by a user's finger to facilitate swinging of the door about its hinge axis. The first locking formations are preferably spaced apart to engage spaced apart points on a periphery of the door. One of the first locking formations is preferably associated with an end of the door adjacent the floor of the body. Another of the first locking formations is preferably associated with an end of the door adjacent the top of the body. The first locking formations are preferably hingedly connected to the body. The first locking formations are preferably integrally formed in a portion of the body, and more preferably the first locking formations are formed by at least one slot extending through a portion of the body. A hinge axis of at least one of the first locking formations is preferably perpendicular to a hinge axis of the door. Hinge axes of two of the first locking formations are preferably perpendicular to a hinge axis of the door. More preferably, the hinge axes of the two first locking formations are formed in different surfaces of the body. Even more preferably, the hinge axis of a first of the two first locking formations is located in a surface of the body generally parallel to the top and the hinge axis of a second of the two first locking formations is located in a surface of the body extending at an angle to the top. Preferably, the first of the two first locking formations is formed in the top of the body. More preferably, the second of the two first locking formations is formed in a wall extending between the floor and the top of the body. At least one tongue preferably extends from one of the door and the body to engage a corresponding at least one opening in the other of the door and body when the door is in the closed position. A first said tongue preferably extends from an end of the door adjacent the top of the body to engage a corresponding said opening in the body. A second said tongue preferably extends from the body, adjacent the floor, to engage an end of the door adjacent the floor. The door is preferably rotatable about its hinge axis relative to the body through at least 90 degrees, and more preferably through between 90 and 180 degrees. At least a portion of the door is preferably translucent to allow the amount of bait in the station to be judged when the door is in the closed position.

In a second family of embodiments, a hinge axis of the door preferably extends generally parallel with a surface of the body, more preferably the top of the body. The door hinge axis is preferably located inboard of ends of the door, such that the door can be swung about its hinge axis by pressing on an end of the door outboard of the hinge axis. The first locking formations are preferably spaced apart to engage spaced apart points on a periphery of the door. At least one of the first locking formations is preferably located on one side of the door hinge axis and at least another of the first locking formations is preferably located on an opposite side of the door hinge axis. The first locking formations are preferably hingedly connected to the body. The first locking formations are preferably integrally formed in a portion of the body, and more preferably the first locking formations are formed by at least one slot extending through a portion of the body. The first locking formations are preferably formed in walls of the body that extend between the floor and top of the body. The relative positions of the first locking formations and the door hinge axis preferably require a user to use both hands to open the door. At least one of the first locking formations is preferably located on one side of the door hinge axis and is preferably engageable with an inside of the door. At least another of the first locking formations is located on an opposite side of the door hinge axis and is preferably engageable with an outside of the door. At least three of the first locking formations and corresponding second locking formations are preferably provided. At least a portion of the door is preferably translucent to allow the amount of bait in the station to be judged when the door is in the closed position.

In a third family of embodiments, a hinge axis of the door preferably extends generally parallel with the floor of the body. The door preferably includes a side portion cooperating with the walls of the body to enclose the station and a cover portion cooperating with the top of the body to enclose the station when the door is in the closed position. The first locking formations are preferably associated with an end of the door distal from the door hinge axis. The first locking formations are preferably hingedly connected to the body. The first locking formations are preferably integrally formed in a portion of the body, and may be formed by at least one slot extending through a portion of the body. The door preferably includes openings, with a periphery of the openings defining the second locking formations engageable by the first locking formations to secure the door in the closed position. A raised portion of the door preferably extends above the openings. When the door is in the closed position, the first locking formations are preferably spaced apart around the raised portion. The first locking formations are preferably resiliently biased outwardly, away from the raised portion, into engagement with the door. Accordingly, a user must manipulate the first locking formations inwardly toward the raised portion to release the locking mechanism for movement of the door from the closed position to the open position. At least three of the first locking formations and corresponding second locking formations are preferably provided. At least a portion of the door is preferably translucent to allow the amount of bait in the station to be judged when the door is in the closed position.

Preferred embodiments are described below, by way of example only, with reference to the accompanying drawings, in which:

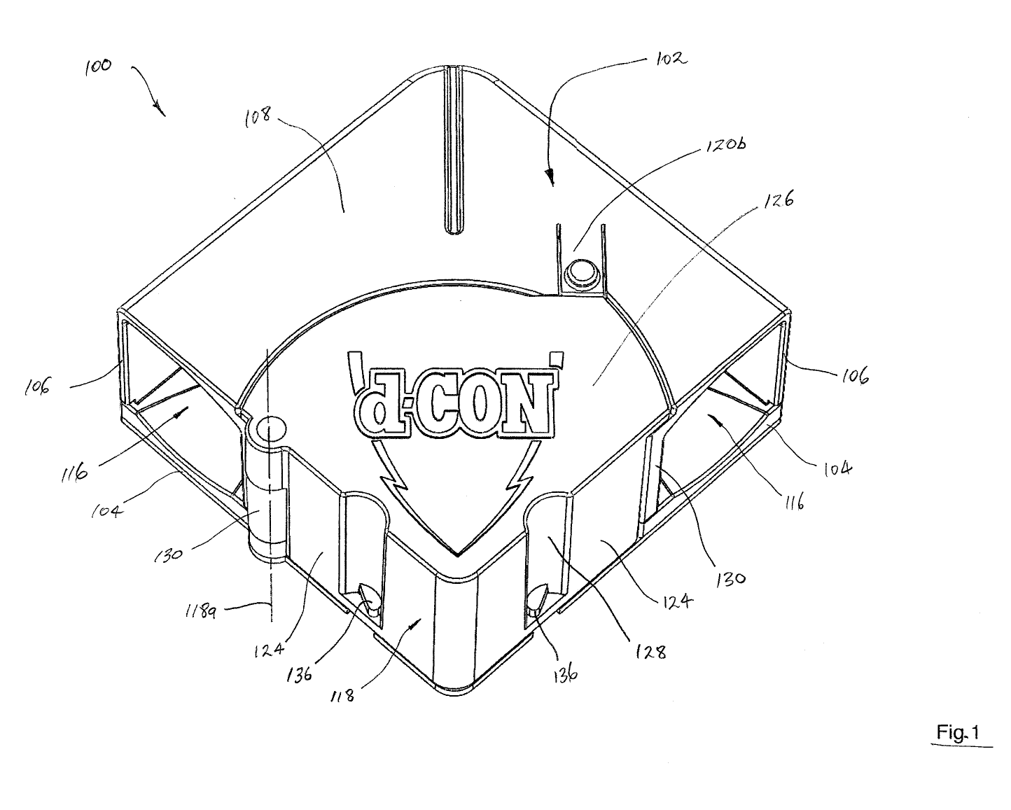

FIG. 1 is a top perspective view of a first embodiment of a dispensing device for rodent baits, shown with its door closed;

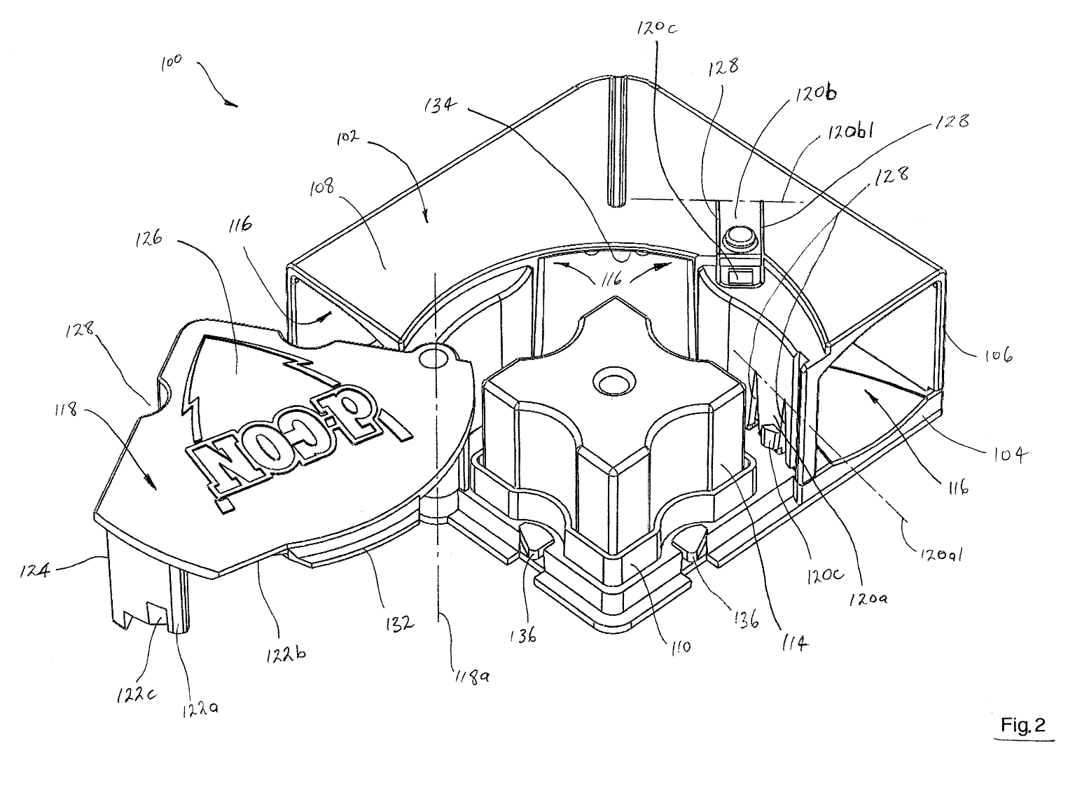

FIG. 2 is a top perspective view of the dispensing device of FIG. 1, shown with its door open;

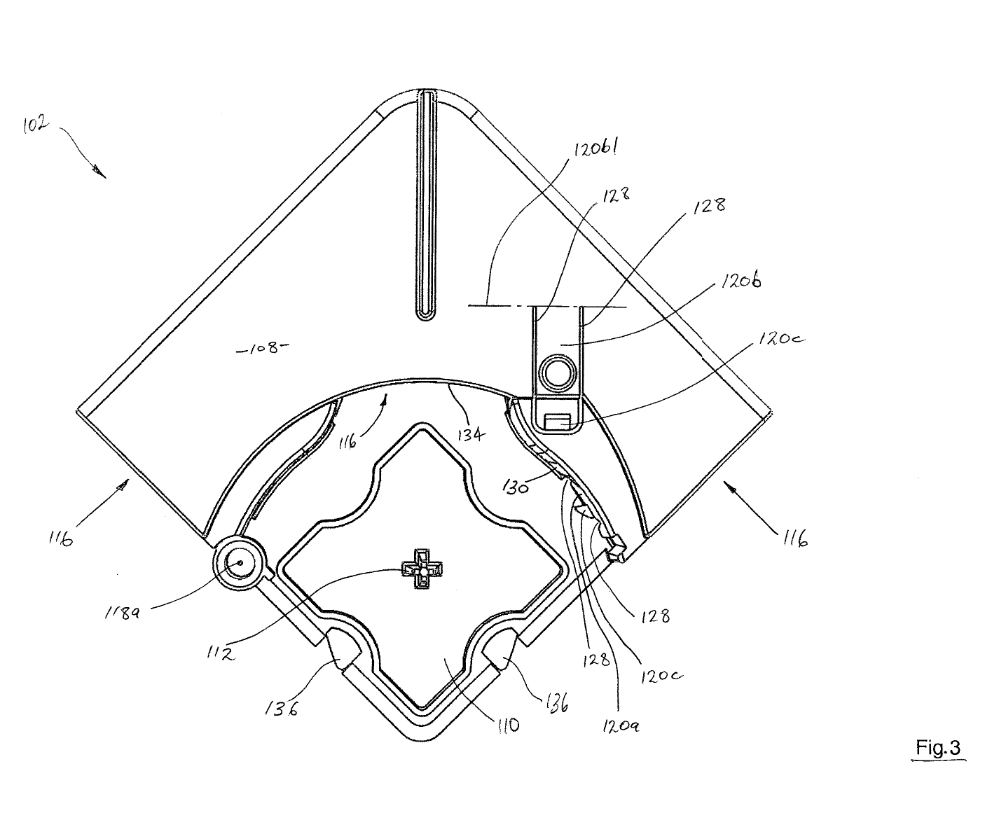

FIG. 3 is a top plan view of the dispensing device of FIG. 1, with the door removed to show internal components of the device body;

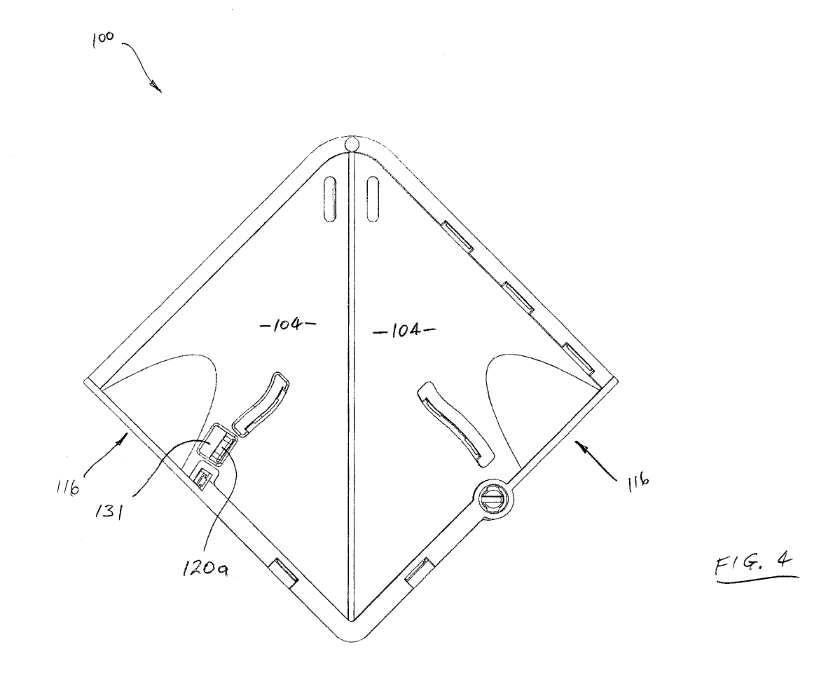

FIG. 4 is an underside plan view of the dispensing device of FIG. 1;

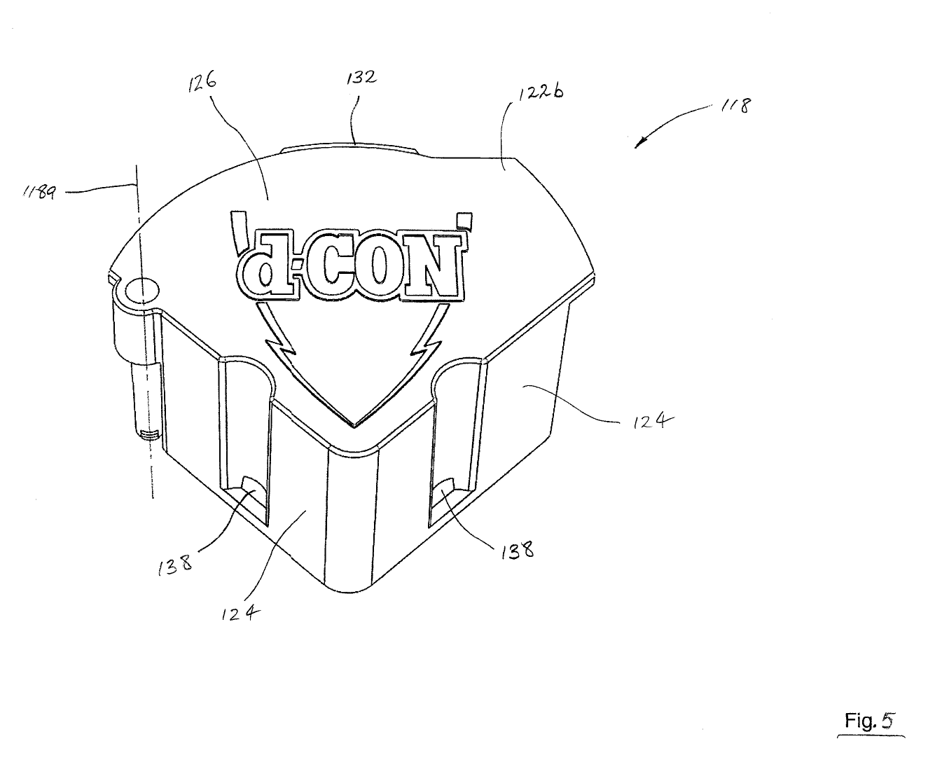

FIG. 5 is a top front perspective view of the door of the dispensing device of FIG. 1;

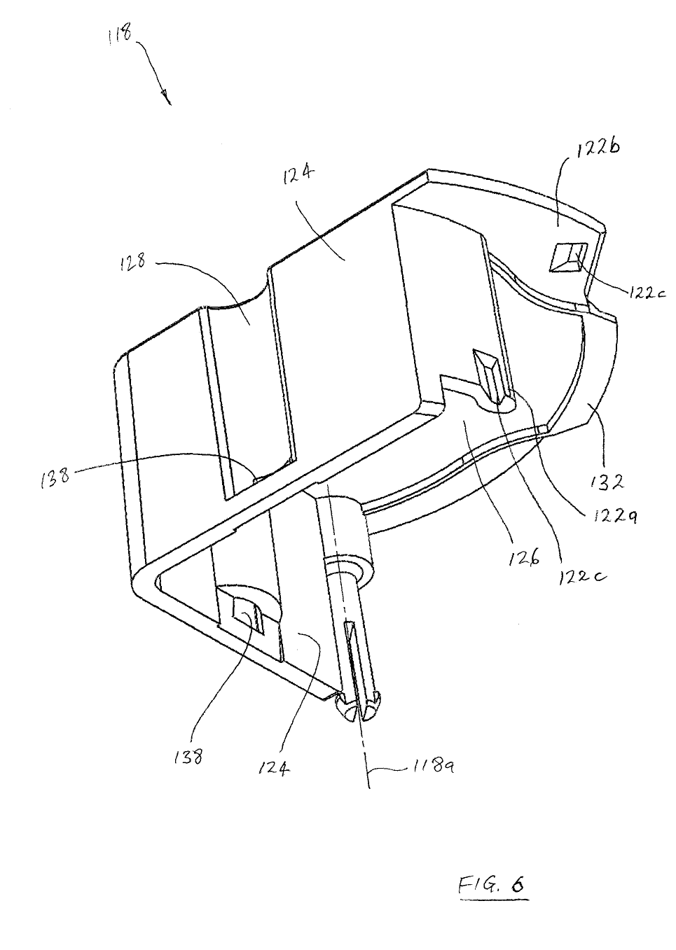

FIG. 6 is an underside perspective view of the door of the dispensing device of FIG. 1;

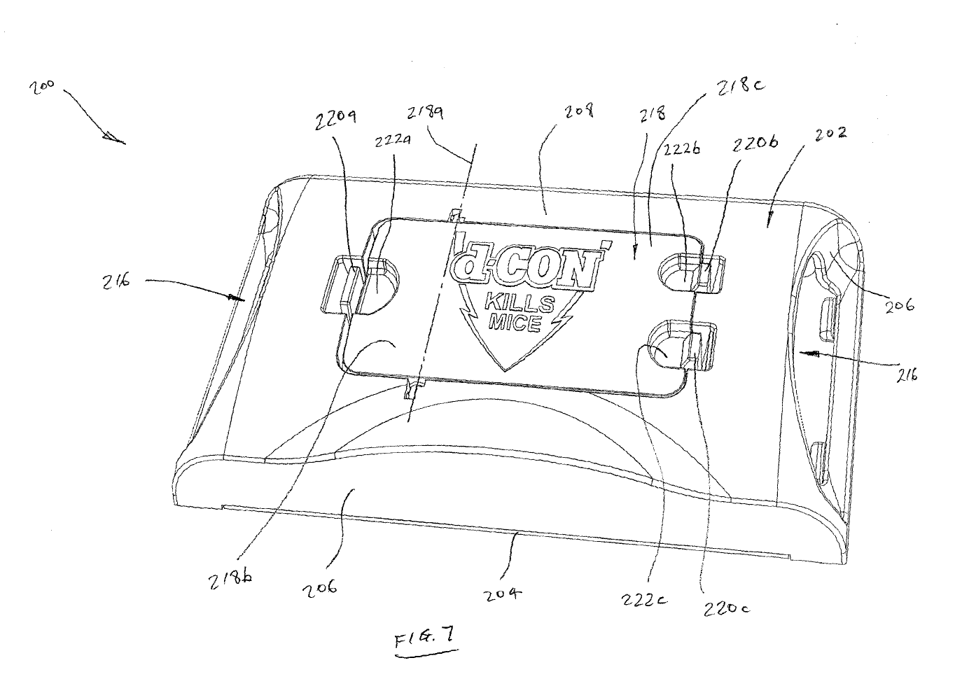

FIG. 7 is a top perspective view of a second embodiment of a dispensing device for rodent baits, shown with its door closed;

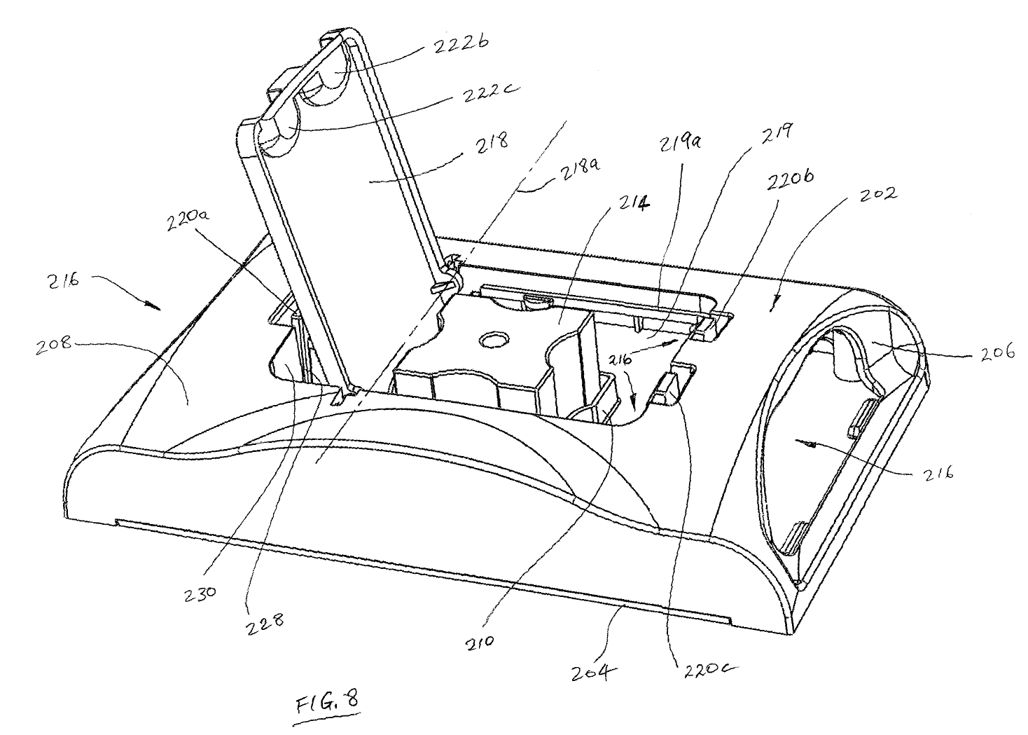

FIG. 8 is a top perspective view of the dispensing device of FIG. 7, shown with its door open;

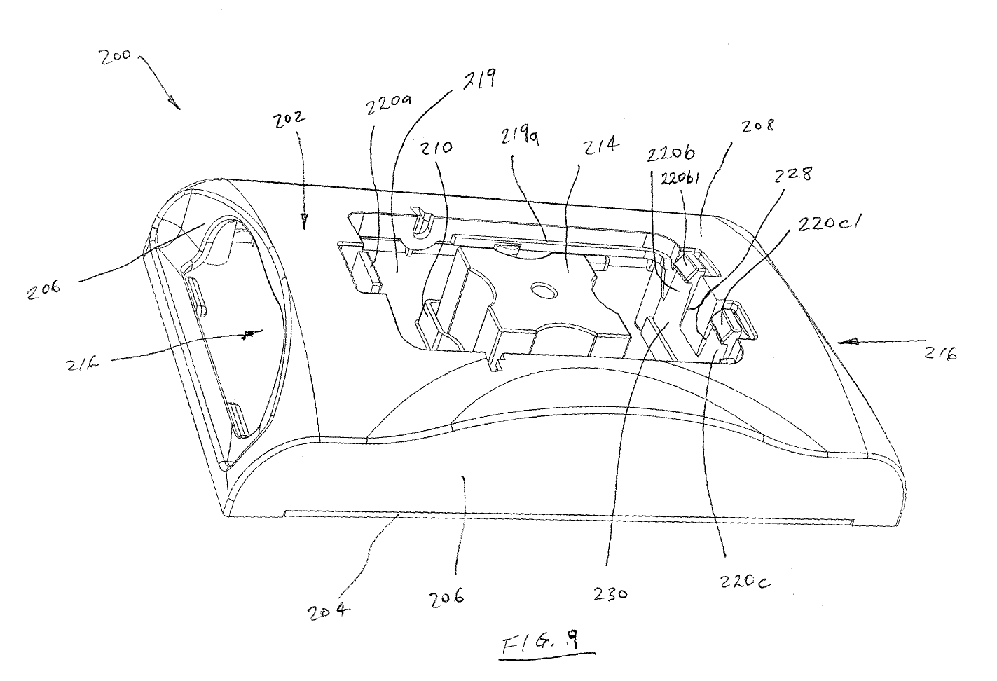

FIG. 9 is a second top perspective view of the dispensing device of FIG. 7, shown with its door removed to allow internal components to be seen;

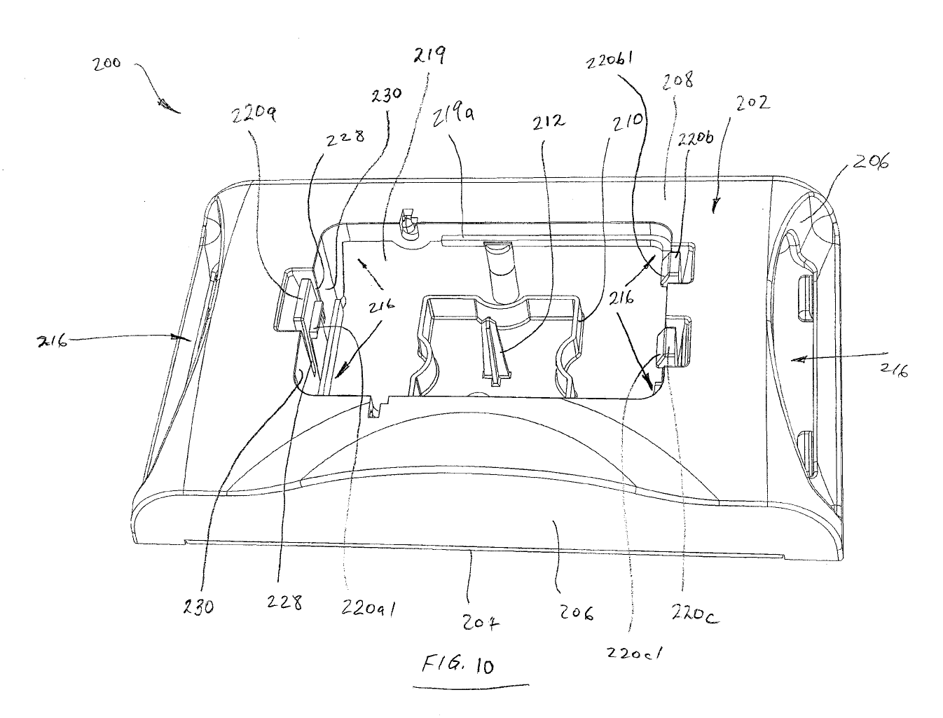

FIG. 10 is a third top perspective view of the dispensing device of FIG. 7, shown with its door removed to allow internal components to be seen;

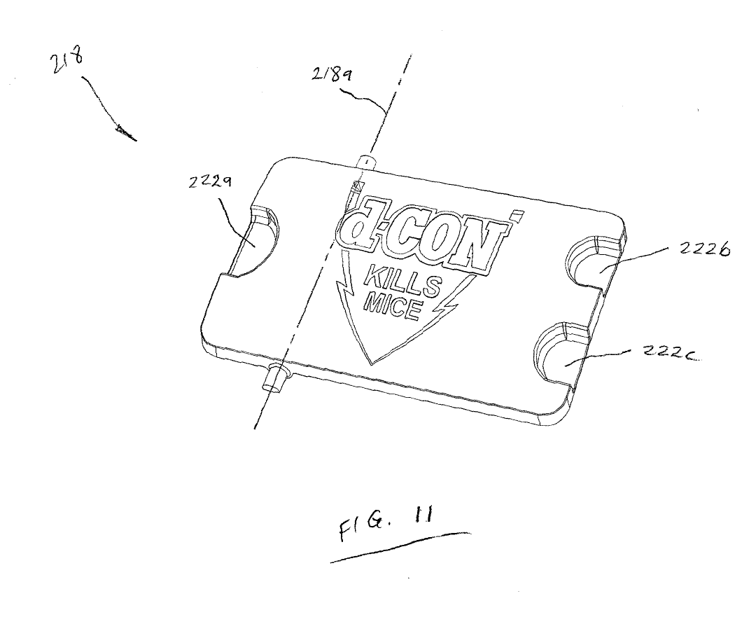

FIG. 11 is a perspective view of the door of the dispensing device of FIG. 7;

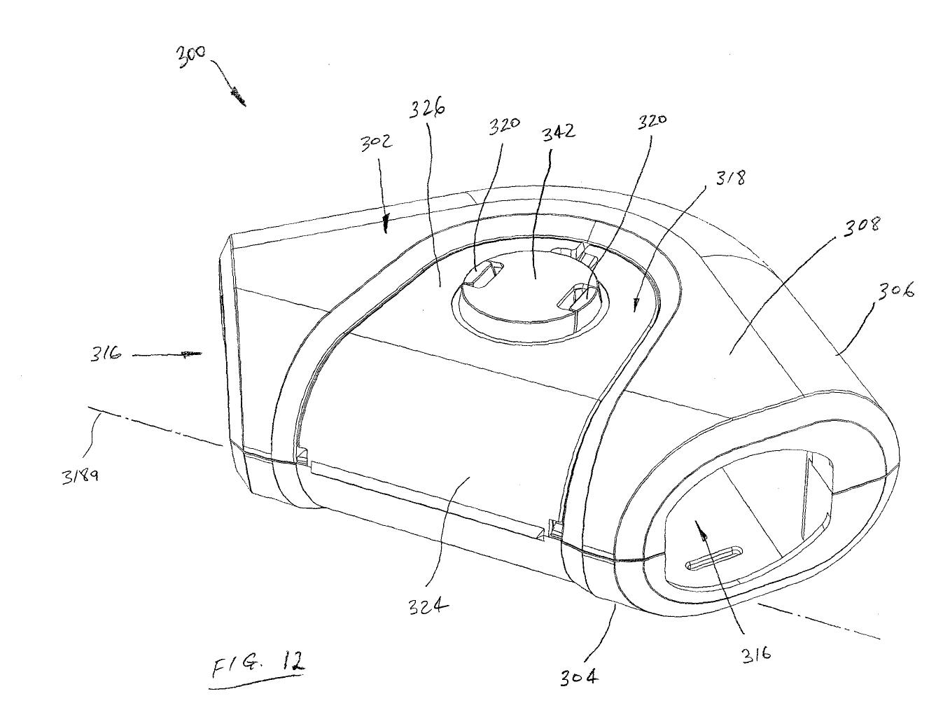

FIG. 12 is a front perspective view of a third embodiment of a dispensing device for rodent baits, shown with its door closed;

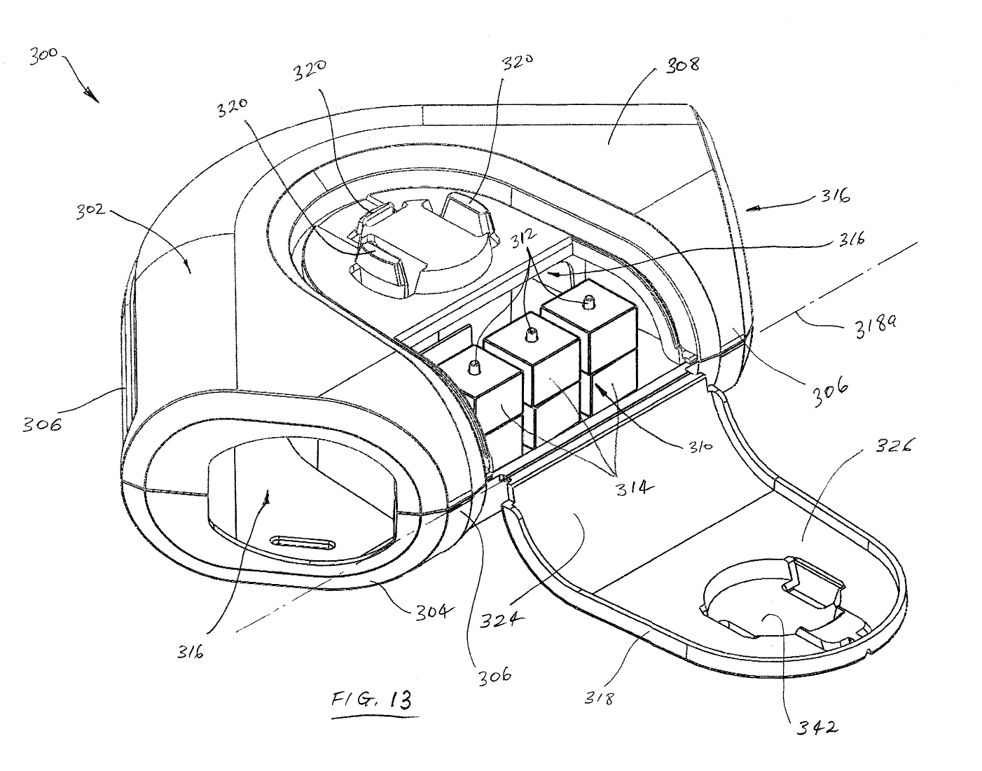

FIG. 13 is a front perspective view of the dispensing device of FIG. 12, shown with its door open; and

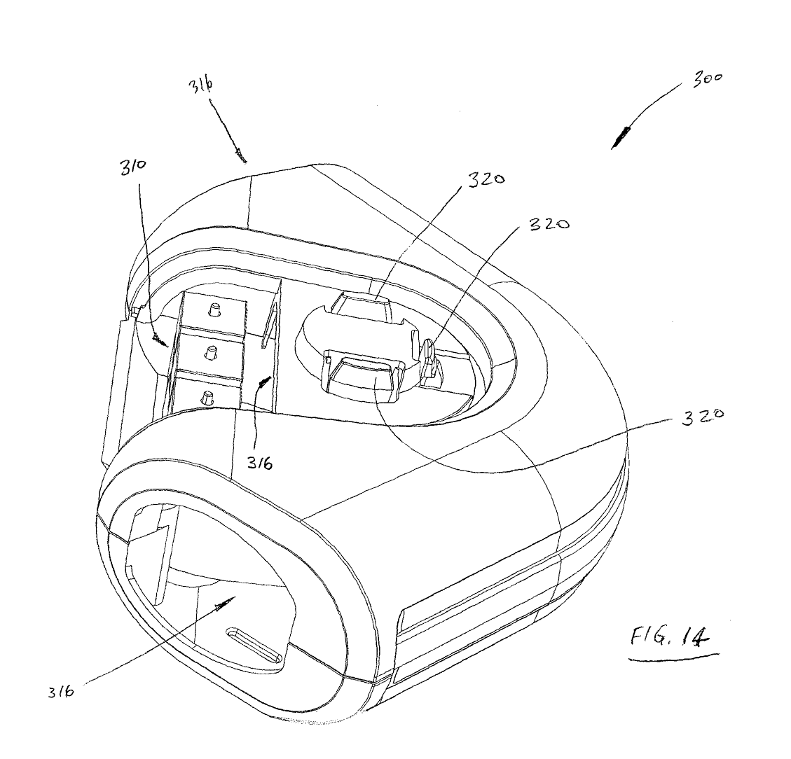

FIG. 14 is a side perspective view of the dispensing device of FIG. 12, shown with its door removed to allow internal components to be seen; and

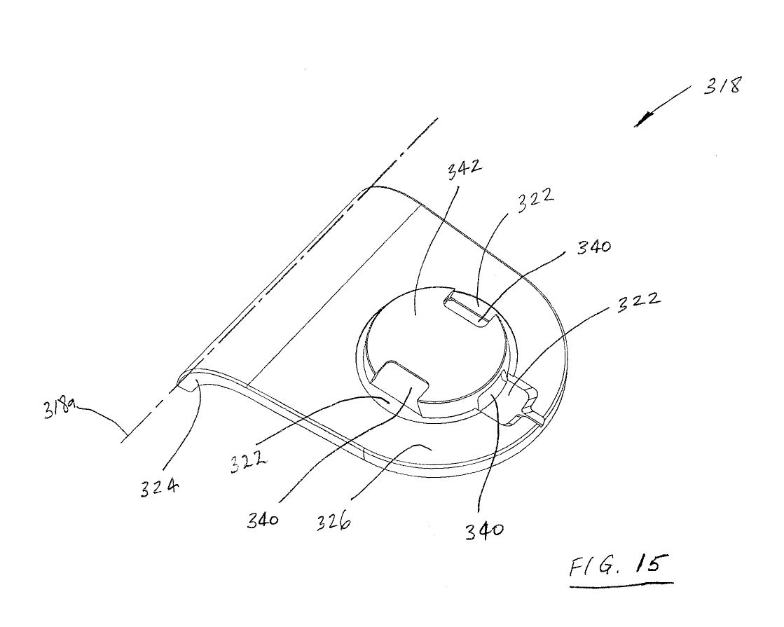

FIG. 15 is a top perspective view of the door of the dispensing device of FIG. 12.

Referring to FIGS. 1-6 of the drawings, there is shown a first embodiment of a dispensing device 100 for rodent baits. The dispensing device 100 includes a body 102 having a floor 104, walls 106 extending from the floor and a top 108 extending 30 between the walls 106. A rodent bait station 110 is located on the body 102. A locating spike 112 extends from the bait station 110 for engagement by a bait 114. A race 116 extends into the body 102 for permitting rodent access to the bait station 110. A door 118 is hingedly connected to the body 102 about a hinge axis 118a generally orthogonal to the floor 104. The door 118 is movable between a closed position, as shown in FIG. 1, in which the door 118 covers the bait station 110, and an open position, as shown in FIG. 2, for permitting user access to the bait station 110 for bait replenishment.

A locking mechanism is associated with the door 118 for releasably securing the door in the closed position of FIG. 1. The locking mechanism includes two independently manually manipulable first locking formations 120a, 120b on the body 102 and two corresponding second locking formations 122a, 122b on the door 118. The first locking formations 120a, 120b are resiliently biased into locking engagement with the second locking formations 122a, 122b to releasably secure the door 118 in the closed position of FIG. 1. The locking mechanism is adapted such that each of the first locking formations 120a, 120b must be simultaneously manipulated out of locking engagement with the corresponding second locking formations 122a, 122b to release the door 118 for movement from the closed position of FIG. 1 to the open position of FIG. 2. The relative positions of the first locking formations 120a, 120b are such that a user must manipulate each of the first locking formations with a different finger of the user's hands.

Three user actions are required to open the door 118. The provision of the two pairs of first and second locking formations 120a, 120b, 122a, 122b, requiring simultaneous independent actuation, provide two of the user actions. The third user action required is manual swinging of the door 118 between the closed and open positions, respectively of FIGS. 1 and 2.

The door 118 includes a side portion 124 cooperating with the walls 106 of the body 102 to enclose the bait station 110 and a cover portion 126 cooperating with the top 108 of the body to enclose the bait station 110 when the door is in the closed position of FIG. 1. The side portion 124 includes a recess 128 for manual engagement by a user's finger to facilitate swinging of the door 118 about its hinge axis 118a.

The first locking formations 120a, 120b are spaced apart to engage spaced apart points on a periphery of the door 118. One of the first locking formations 120a is associated with a lower end of the door 118 adjacent the floor of the body. The other of the first locking formations 120b is associated with a top end of the door 118 adjacent the top 108 of the body. The first locking formations 120a, 120b are hingedly connected to the body 102 and are of integral, one piece construction with the portion of the body in which they are formed. The first locking formations 120a, 120b are in the form of tabs formed by respective slots 128 extending through the body 102. The tabs 120a, 120b have projections 120c at their distal ends for engaging corresponding recesses 122c in the second locking formations 122a, 122b. A hinge axis 120b1 of the upper first locking formation 120b is perpendicular to the hinge axis 118a of the door. A hinge axis 120a1 of the lower first locking formation 120a is also perpendicular to the hinge axis 118a of the door. The upper and lower first locking formations 120a, 120b and their hinge axes 120a1, 120b1, are formed in different surfaces of the body, respectively in the top 108 of the body and in a wall 130 of the body extending at right angles to the top 108 and between the floor 104 and the top 108 of the body. As shown in FIG. 4, a free end of the lower first locking formation 120a projects through an opening 131 in the floor 104 for manipulation by a user's finger.

To strengthen the dispensing device 100, a first tongue 132 extends from a top end of the door 118 to engage an opening 134 underneath the top 108 of the body 102 when the door 118 is in the closed position of FIG. 1. Second and third tongues 136 extend from the body 102, adjacent the floor 108, to engage corresponding openings 138 in the lower end of the door 118.

As can be seen by comparing FIGS. 1 and 2, the door 118 is rotatable about its hinge axis 118a relative to the body 102 through almost 180 degrees. The door 118 is translucent to allow the amount of bait 114 in the bait station 110 to be judged when the door is in the closed position of FIG. 1.

Referring to FIGS. 7-11, there is shown a second embodiment of a dispensing device 200 for rodent baits. The dispensing device 200 includes a body 202 having a floor 204, walls 206 extending from the floor and a top 208 extending between the walls 206. A rodent bait station 210 is located on the body 202. A locating spike 212 extends from the bait station 210 for engagement by a bait 214. A race 216 extends into the body 202 for permitting rodent access to the bait station 210. A door 218 is hingedly connected, about a hinge axis 218a, to the body 202 to selectively cover an opening 219 in the top of the body above the bait station 210. The door 218 is movable between a closed position, as shown in FIG. 7, in which the door 218 covers the bait station 210, and an open position, as shown in FIG. 8, for permitting user access to the bait station 210 for bait replenishment. In the closed position of FIG. 7, the door 218 engages a rim 219a around the opening 219.

A locking mechanism is associated with the door 218 for releasably securing the door in the closed position of FIG. 7. The locking mechanism includes three independently manually manipulable first locking formations 220a, 220b, 220c on the body 202 and three corresponding second locking formations 222a, 222b, 222c, in the form of finger recesses, on the door 218. The first locking formations 220a, 220b, 220c are resiliently biased into locking engagement with the second locking formations 222a, 222b, 222c to releasably secure the door 218 in the closed position of FIG. 7. The locking mechanism is adapted such that each of the first locking formations 220a, 220b, 220c must be simultaneously manipulated out of locking engagement with the corresponding second locking formations 222a, 222b, 222c to release the door 218 for movement from the closed position of FIG. 7 to the open position of FIG. 8.

The hinge axis 218a of the door extends generally parallel with the top 208 of the body and is located inboard of opposite ends 218b, 218c of the door. Accordingly, the door 218 can be swung about its hinge axis 218a by pressing on end 218b of the door, outboard of the hinge axis 218a.

The first locking formations 220a, 220b, 220c are spaced apart to engage spaced apart points on a periphery of the door 218. One of the first locking formations 220a is located on one side of the door hinge axis 218a and the other first locking formations 220b, 220c are located on an opposite side of the door hinge axis 218a. The first locking formations 220a, 220b, 220c are hingedly connected to the body 202 and are of integral, one piece construction with walls 230 of the body that extend between the floor 204 and top 208. The first locking formations 220a, 220b, 220c are in the form of tabs formed by respective slots 228 extending through the walls 230 of the body.

The first locking formations 220a, 220b, 220c each include a catch portion 220a1, 220b1, 220c1 for engaging the respective second locking formation 222a, 222b, 222c on the door 218. The catch portion 220a1 of first locking formation 220a engages the inside (bottom) of the second locking formations 222a. The catch portions 220b1, 220c1 of first locking formations 220b and 220c engage the outside (top) of the second locking formations 222b, 222c. Accordingly, with any of the locking formations engaged, rotation of the door 218 is prevented.

The door 218 is translucent to allow the amount of bait 214 in the bait station 210 to be judged when the door 218 is in the closed position of FIG. 7.

The relative positions of the first locking formations 220a, 220b, 220c are such that a user must manipulate each of the first locking formations with a different finger of the user's hands. The relative positions of the first locking formations and the door hinge axis also require a user to preferably use both hands to open the door.

Four user actions are required to open the door 218. The provision of the three pairs of first and second locking formations 220a, 220b, 220c, 222a, 222b, 222c requiring simultaneous independent actuation, provide three of the user actions. The fourth user action required is manual swinging of the door 218 between the closed and open positions by pressing down on the side of the door 218 closest locking formations 220a, 222a.

Referring to FIGS. 12-15, there is shown a third embodiment of a dispensing device 300 for rodent baits. The dispensing device 300 includes a body 302 having a floor 304, walls 306 extending from the floor and a top 308 extending between the walls 306. A rodent bait station 310 is located on the body 302. Locating spikes 312 extend from the bait station 310 for engagement by baits 314. A race 316 extends into the body 302 for permitting rodent access to the bait station 310. A door 318 is hingedly connected, about a hinge axis 318a generally parallel to the floor 304, to the body 302. The hinge between the door 318 and the body 302 is integrally moulded, such that the door and body are of integral, one-piece construction. The door 318 is movable between a closed position, as shown in FIG. 12, in which the door 318 covers the bait station 310, and an open position, as shown in FIG. 13, for permitting user access to the bait station 310 for bait replenishment.

A locking mechanism is associated with the door 318 for releasably securing the door in the closed position of FIG. 12. The locking mechanism includes three independently manually manipulable first locking formations 320 on the body 302 and three corresponding second locking formations 322 on the door 318. The first locking formations 320 are resiliently biased into locking engagement with the second locking formations 322 to releasably secure the door 318 in the closed position of FIG. 12. The locking mechanism is adapted such that each of the first locking formations 320 must be simultaneously manipulated out of locking engagement with the corresponding second locking formations 322 to release the door 318 for movement from the closed position of FIG. 12 to the open position of FIG. 13.

The door 318 includes a side portion 324 cooperating with the walls 306 of the body 302 to enclose the bait station 310 and a cover portion 326 cooperating with the top 308 of the body to enclose the bait station 310 when the door is in the closed position of FIG. 12.

The first locking formations 320 are associated with an end of the door 318 distal from the door hinge axis 318a. The first locking formations 320 are hingedly connected to the body 302 and are in the form of tabs of integral, one piece construction, with the top 308 of the body. The door 318 includes openings 340, with a periphery of the openings 340 defining the second locking formations 322, engageable by the first locking formations 320 to secure the door 318 in the closed position of FIG. 12. The first locking formations extend from the top 308 of the body, under the door 318 and up to engage the openings 340 in the door.

A raised portion 342 of the door 318 extends above the openings 340. With the door in the closed position of FIG. 12, the first locking formations 320 are spaced apart around the raised portion 342 and are resiliently biased outwardly, away from the raised portion 342, into engagement with the second locking formations 322 formed in the door 318. Accordingly, a user must manipulate the first locking formations 320 inwardly toward the raised portion 342 to release the locking mechanism for movement of the door 318 from the closed position of FIG. 12 to the open position of FIG. 13.

The door 318 and floor 304 are translucent to allow the amount of bait 314 in the bait station 310 to be judged when the door is in the closed position of FIG. 12.

The relative positions of the first locking formations 320 and their association with the raised portion 342 of the door 318 are such that a user must manipulate each of the first locking formations 320 with a different finger of the user's hands.

Four user actions are required to open the door 318. The provision of the three pairs of first and second locking formations 320, 322 requiring simultaneous independent actuation, provide three of the user actions. The fourth user action required is manual swinging of the door 318 between the closed and open positions.

In all of the above described embodiments, the dispensing devices 100, 200, 300 are formed from polypropylene.

It will be appreciated by persons skilled in the art that numerous variations and/or modifications may be made to the embodiments described above with reference to the drawings without departing from the scope of the present disclosure as broadly defined. The present embodiments are, therefore, to be considered in all respects as illustrative and not restrictive. Examples of possible modifications include, but are not limited to:
hinging the doors 118, 218, 318 around different axes;
changing the positions of the first and second locking formations, and/or their number, such that different user hand actions are required to unlock the door 118, 218, 318;
providing additional first and second locking formations to increase the complexity of unlocking the door to allow access to the bait station; and/or
forming the dispensing devices 100, 200, 300 from other plastics, such as polypropylene, polycarbonate, HDPE, LDPE, nylon and PET.

1. A dispensing device for rodent baits, the dispensing device comprising:
a body having a floor, walls extending from the floor and a top extending between the walls;
a station located in the body for receiving a rodent bait;
a race extending into the body for permitting rodent access to the station;
a door connected to the body, the door being movable between a closed position,
in which the door covers the station, and an open position for permitting user access to the station for bait replenishment;
a locking mechanism associated with the hinged door for releasably securing the door in the closed position, the locking mechanism including:
a plurality of independently manually manipulable first locking formations on one of the body and door and corresponding second locking formations on the other of the body and door, the first locking formations being resiliently biased into locking engagement with the second locking formations to releasably secure the door in the closed position;
the locking mechanism being adapted such that each of the first locking formations must be simultaneously manipulated out of locking engagement with the corresponding second locking formations to release the door for movement from the closed position to the open position;
wherein the first locking formations are adapted such that a user must manipulate each of the first locking formations with a different finger of the user's hands.

2. A dispensing device according to claim 1, wherein the first locking formations are adapted such that they must be manipulated with a different finger of the user's hands by virtue of the relative positions of the first locking members.

3. A dispensing device according to claim 1, wherein at least three user actions are required to open the door.

4. A dispensing device according to claim 3, wherein two of the first locking formations and corresponding second locking formations are provided and define two of the required user actions, and wherein the third user action is manual movement of the door between the closed and open positions.

5. A dispensing device according to claim 1, wherein a locating spike extends from the station for engagement by a bait.

6. A dispensing device according to claim 1, wherein the first locking formations are hingedly connected to the body and are integrally formed, in one-piece construction, in a portion of the body.

7. A dispensing device according to claim 1, wherein the door is hingedly connected to the body for swinging movement between the closed and open positions.

8. A dispensing device according to claim 7, wherein a hinge axis of the door extends generally orthogonal to the floor of the body.

9. A dispensing device according to claim 8, wherein the door includes a side portion cooperating with the walls of the body to enclose the station and a cover portion cooperating with the top of the body to enclose the station when the door is in the closed position.

10. A dispensing device according to claim 9, wherein the side portion includes a recess for manual engagement by a user's finger to facilitate swinging of the door about its hinge axis.

11. A dispensing device according to claim 8, wherein one of the first locking formations is associated with an end of the door adjacent the floor of the body and another of the first locking formations is associated with an end of the door adjacent the top of the body.

12. A dispensing device according to claim 11, wherein the first locking formations are hingedly connected to the body and hinge axes of two of the first locking formations are formed in different surfaces of the body.

13. A dispensing device according to claim 12, wherein the hinge axis of a first of the two first locking formations is located in a surface of the body generally parallel to the top and the hinge axis of a second of the two first locking formations is located in a surface of the body extending at an angle to the top.

14. A dispensing device according to claim 12, wherein the hinge axes of the two first locking formations are substantially perpendicular to the hinge axis of the door.

15. A dispensing device according to claim 12, wherein a first of the two first locking formations is formed in the top of the body and a second of the two first locking formations is formed in a wall extending between the floor and the top of the body.

16. A dispensing device according to claim 1, wherein a hinge axis of the door hinge is located inboard of ends of the door, such that the door can be swung about its hinge axis by pressing on an end of the door outboard of the hinge axis.

17. A dispensing device according to claim 16, wherein at least one of the first locking formations is located on one side of the door hinge axis and at least another of the first locking formations is located on an opposite side of the door hinge axis.

18. A dispensing device according to claim 16, wherein at least one of the first locking formations is engageable with an inside of the door and at least another of the first locking formations is engageable with an outside of the door.

19. A dispensing device according to claim 16, wherein the first locking formations are formed in walls of the body that extend between the floor and top of the body.

20. A dispensing device according to claim 16, wherein the relative positions of the first locking formations and the door hinge axis require a user to use both hands to open the door.

21. A dispensing device according to claim 16, wherein a hinge axis of the door extends generally parallel with the top of the body.

22. A dispensing device according to claim 1, wherein the door includes openings, with a periphery of the openings defining the second locking formations engageable by the first locking formations to secure the door in the closed position.

23. A dispensing device according to claim 22, wherein the door includes a raised portion extending above the openings.

24. A dispensing device according to claim 23, wherein the first locking formations are spaced apart around the raised portion when the door is in the closed position.

25. A dispensing device according to claim 23, wherein the first locking formations are resiliently biased outwardly, away from the raised portion, into engagement with the door.

26. A dispending device according to claim 22, wherein a hinge axis of the door extends generally parallel with the floor of the body.

27. A dispensing device according to claim 22, wherein the first locking formations are associated with an end of the door distal from the door hinge axis.

28. A dispensing device according to claim 1, wherein the door includes a side portion cooperating with the walls of the body to enclose the station and a cover portion cooperating with the top of the body to enclose the station when the door is in the closed position.

29. A dispensing device according to claim 1, wherein at least three of the first locking formations and corresponding second locking formations are provided.

30. A dispensing device according to claim 1, further comprising at least one tongue extending from one of the door and the body to engage a corresponding at least one opening in the other of the door and body when the door is in the closed position.

31. A dispensing device according to claim 1, wherein at least a portion of the door is translucent to allow the amount of bait in the station to be judged when the door is in the closed position.

32. (canceled)
